(19) United States
(12) Patent Application Publication
(10) Pub. No.: US 2007/0208455 A1
(43) Pub. Date: Sep. 6, 2007

(54) System and a method for sorting items out of waste material

(75) Inventors: Heiman Salle Bollegraaf, Groningen (NL); Gerhardus Frans Niewold, Hoogezand (NL); Hermannus Johannes Maria Legtenberg, Winschoten (NL)

Correspondence Address: PEARNE & GORDON LLP, 1801 EAST 9TH STREET, SUITE 1200, CLEVELAND, OH, 44114-3108, US

(73) Assignee: Machinefabriek Bollegraaf Appingedam B.V., Appingedam (NL)

(21) Appl. No.: 11/543,488

(22) Filed: Oct. 5, 2006

Related U.S. Application Data
(60) Provisional application No. 60/779,472, filed on Mar. 6, 2006.

(30) Foreign Application Priority Data
Mar. 3, 2006 (EP) 06075509.7

(51) Int. Cl. G06F 7/00

(52) U.S. Cl. 700/223

(57) ABSTRACT

For sorting items out of waste material, a system is provided including a conveyor for transporting waste material, a detector for identifying and locating items of the waste material on the conveyor, at least one depositing area along the conveyor, at least one robot along the conveyor; and a control circuitry communicating with the detector and with the robots. The control circuitry is arranged for controlling the robot or at least one of the robots to pick-up located items of the waste material on the conveyor and to deposit picked-up items at the at least one depositing area. A method for sorting items out of waste material is also disclosed.

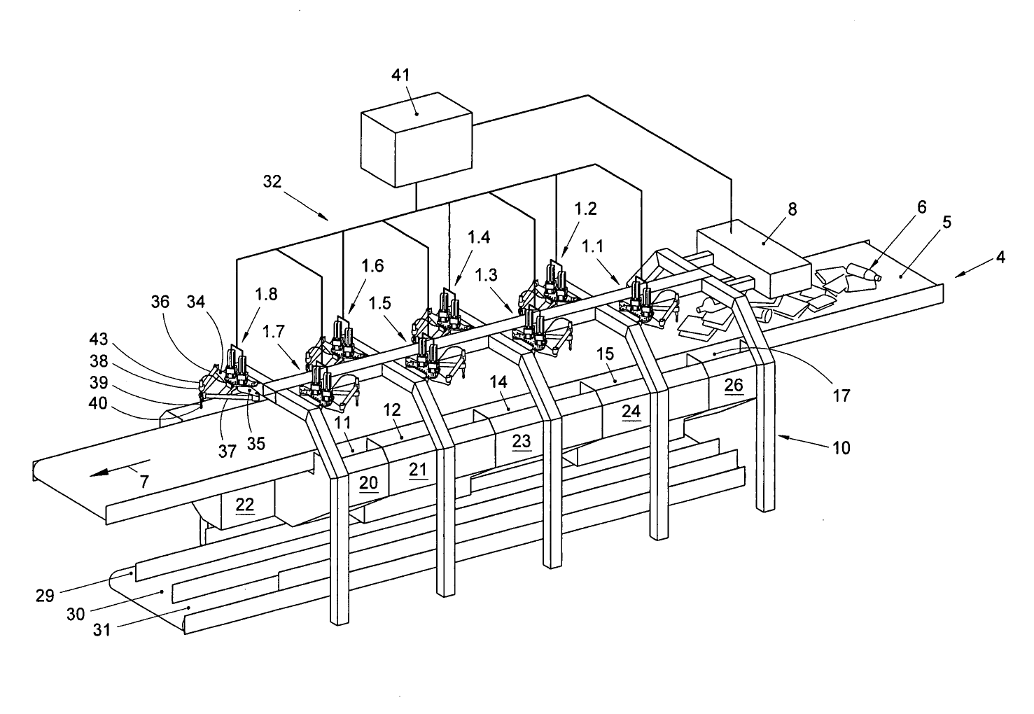

This application claims the benefit of U.S. Provisional Patent Application Ser. No. 60/779,472 filed Mar. 6, 2006, the contents of which are incorporated herein by reference in their entirety.

### TECHNICAL FIELD AND BACKGROUND ART

The invention relates to a system and to a method for sorting items out of waste material on a conveyor.

In the recycling of waste, it is generally an objective to sort the material into fractions that are homogeneous in the sense of being of the same material or category of materials and/or of the same color. For example, polymers must often be of nearly identical composition in order to allow processing into a granulate from which products of a good quality can be manufactured. When recycling glass, it is important to combine the same colors. In some cases fulfillment of a negative sorting criterion is of particular importance, such as absence of colored items in a fraction of white or transparent items, or absence of PVC items in a fraction of polyolefin items.

For the sorting of items out of waste material, it is known to pass a stream of waste material along a detector that recognizes and localizes items having particular properties and removing the identified items from the material downstream of the detector by passing the stream over an array of nozzles extending across the stream of material and generating an air pulse out of a nozzle when an item to be sorted out is in front of the nozzle. The selection of the nozzles and the timing of the air pulses is controlled by control circuitry communicating with the detector and with valve control members.

A disadvantage of this manner of sorting is, that after detection only one fraction of the materials can be sorted out and that sorting out of another fraction the materials requires the stream of remaining waste material to be passed along a detector again, because the sorting out of items causes too much disturbance of the other items on the conveyor track to allow another fraction of the material to be selectively blown out of the stream without renewed detection of the location of such items.

### SUMMARY OF THE INVENTION

It is an object of the invention to provide a solution that allows sorting a fraction of the items of waste material on a conveyor without disturbing the items not sorted out to such an extent that renewed detection of a next fraction of items would not be required before automatic sorting of a next fraction of items or a next item of the same fraction out of the waste material on the conveyor can be carried out.

According to the invention, this object is achieved by providing a system for sorting items out of waste material, including a conveyor for transporting waste material, a detector for identifying and locating items of the waste material on the conveyor, at least one depositing area along the conveyor, at least one robot along the conveyor, and a control circuitry communicating with the detector and with the robots for controlling the robot or at least one of the robots to pick-up located items of the waste material on the conveyor and to deposit picked-up items in the at least one depositing area.

The invention can also be embodied in a method for sorting items out of waste material, for which at least one depositing area along a conveyor track is provided and at least one robot along the conveyor track is provided and in which waste material is transported along the conveyor track, items of the waste material on the conveyor track are identified and located; and the robot is or the robots are controlled to pick-up located items of the waste material on the conveyor track and to deposit picked-up items at the depositing area or areas.

Further aspects, effects and details of the invention are set forth in the detailed description with reference to examples of which some are shown in the schematic drawings.

### BRIEF DESCRIPTION OF THE DRAWINGS

The drawing is a perspective view of an example of a system according to the invention in which control circuitry is shown schematically.

### MODES FOR CARRYING OUT THE INVENTION

In the example of a system for sorting items out of waste material shown in the drawing, eight robots 1.1-1.8 are arranged along a conveyor 4 of which a top deck forms a conveyor track 5 along which waste material 6 can be conveyed in a direction designated with an arrow 7. In the drawing, for the sake of clarity of the drawing, the waste material 6 is only shown on an upstream section of the conveyor track 5. However, in operation, waste material will normally found over the whole length of the conveyor track 5, the amount of material on the track reducing at each robot 1.1-1.8. Depending on the requirements with respect to capacity and number of categories into which materials are to be sorted, the number of robots may be larger or smaller than eight and also a single robot is conceivable within the framework of the present invention, for instance in combination with an array of air valves downstream of the robot for sorting items out using air pulses.

Upstream of the robots 1.1-1.8, a detector unit 8 is arranged for identifying and locating items of the waste material 6 on the conveyor 4. Depending on the materials to be sorted and the sorting requirements, the detector unit may be equipped with one or more detectors, such as an infrared camera for distinguishing several material types from each other, a color sensitive camera for sorting materials by color and/or an array of sensors extending across the conveyor. The robots 1.1-1.8, the conveyor 4 and the detector unit 8 are suspended by a frame 10.

For calculating the pick-up position of items identified via the detector unit 8 and to be picked up by one of the robots 1.1-1.8, encoder signals are generated in accordance with displacements of the conveyor track and are used to determine the position of the items to be picked up. However, also other possibilities for calculating the pick-up position of items identified via the detector unit 8, for instance by detecting displacement of the conveyor track 5 using the detector unit, or by keeping displacements of the conveyor track 5 in transport direction 7 synchronized with synchronization signals, such as timer signals.

Along the conveyor, a plurality of depositing areas is provided in the form of openings 11-15, 17. In the present example, three of the openings 12, 14, 15 are arranged such that items can be deposited therein from two successive robots 1.1, 1.3, 1.5. The robots 1.1-1.8 are arranged in two rows in longitudinal sense of the conveyor, which is advantageous for increasing sorting capacity, while keeping the installation relatively compact in longitudinal direction of the conveyor 4. The rows of robots are staggered relative to each other, which allows the working areas of the robots to extend across the middle of the conveyor belt, while keeping the risk of interference between neighboring robots relatively low. Such interference would require additional control of the robots to avoid collisions and reduce the productivity of the robots.

A first one of the robots 1.1 is capable of depositing picked-up items in openings 15 and 17. The openings 14, 15 are arranged such that a third one of the robots 1.3 is capable of depositing picked-up items therein, and the openings 12, 14 are arranged such that a fifth robot 1.5 is capable of depositing picked-up items therein. The sevenths robot 1.7 and the openings 11, 12 are arranged such that the seventh robot 1.7 can deposit items in the openings 11, 12. Similarly, the last robot 1.8 above the right hand side of the conveyor 4 is capable of depositing items in opening 13 and in a next upstream opening that is not visible in the drawing.

A disadvantage of such a arrangement could be that robots positioned to operate on for example the left-hand side of the track 5 are incapable of reaching items on the right-hand side of the track, so that such items could not be deposited into associated openings on the left-hand side of the track.

In the present example, this is avoided by providing that the openings 11-15, 17, each communicate with a chute 20-24, 26 leading to one of three conveyor tracks 29-31 underneath the conveyor track 5 from which material is picked up and that the two outer tracks 29, 31 are used for sorting the same material while chutes for depositing material on the central track 30 connect to openings on both sides of the track 5. It is also possible, to arrange the chutes such that material can be led to all tracks for sorted material from openings on both sides of the main conveyor track. The chutes may for instance arranged such lead to the tracks underneath. In the present example, chutes of two different lengths have been provided. The shortest chutes 21, 22, 24 have a length such that these chutes deposit material on the outer track 29 or 31 on the side of the openings 12, 13, 15 to which the chutes 21, 22, 24 connect. The other chutes 20, 23, 26 each have a length and slope such that these chutes end just above the central track 30 and are coupled to chutes from the opposite side of the conveyor track 5, so that items can reach the central track 30 via openings on both sides of the conveyor track 5. The items can then be transported along the conveyor tracks 29-31 to separate bunks each associated to one or more of the conveyor tracks 29-31.

That the conveyor tracks for sorted material 29-31 are arranged underneath the conveyor track 5 for the material to be sorted is advantageous for obtaining a compact construction occupying little width and easy operator access to the robots and the conveyor track 5 for the material to be sorted.

Many alternative or additional possibilities of leading deposited items to respective storage containers are conceivable. For instance, depositing areas or the chutes may also be arranged to cause items to fall directly into associated bunks or bins. Instead of a plurality of depositing areas, also a single depositing area may be provided. It is also possible to provide that the numbers of depositing areas associated to a storage container are different for different storage containers.

A control circuitry 32 communicates with the detector unit 8 and with the robots 1.1-1.8 for controlling the robots 1.1-1.8 to pick-up located items of the waste material 6 on the conveyor 4 and to deposit picked-up items into the depositing openings 11-15, 17.

In operation, waste material 6 is transported along the conveyor track 5. The detector unit 8 identifies and locate items of the waste material 6 on the conveyor track 5. In accordance with the locations of identified items on the conveyor track 5 and the displacement of the items in transport direction 7, the robots 1.1-1.8 are controlled to pick-up located items of the waste material 6 on the conveyor track 5 and to deposit picked-up items in the depositing openings 11-15, 17. Preferably, the selection of the items to be picked-up and of the category of the openings 11-15, 17 into which the items are deposited is carried out in response to properties of the items that have been detected by the detector unit 8, or otherwise, before the items have been picked up, since this allows the items to be picked-up selectively and to be deposited more quickly and provides flexibility with respect to assignment of categories of items to be picked up by the available robots. However, it is also possible that a determination or a further determination of the fraction of waste to which a picked-up item belongs is made after the robot has picked up the item. This allows examination of the item from nearer by and allows to weigh the item and to sense properties of the item by contacting the item Picking up of items from the waste 6 on the conveyor, allows the items to be picked up without substantially displacing the other items. This allows to subsequently remove other individual located items, without renewed detection. The subsequent removal of other individual located items from the conveyor need not be carried out by a robot, but may also be carried out by other means, such as a row of nozzles via which timed air pulses blowing individual items away from the rest of the waste are applied.

In the present example, the robots 1.1-1.8 each include motors for driving two pivotable arms 34, 35, which are connected via hinged carrier bars 36, 37 to a linear motor 38 through which a vertical arm 39 extends. At the downstream end of the vertical arm, a gripper 40 in the form of a suction nozzle of a flexible material is arranged. A passage to which a vacuum can be applied extends through the gripper 40.

The motors in the housing 33 drive substantially horizontal displacements of the gripper 40 by causing the pivotable arms 34, 35 to pivot, the motion being transferred via the carrier bars 36, 37. The linear motor 38 can drive substantially vertical displacements of the vertical arm 39 and thus of the vertical gripper 40 mounted to the lower end of the vertical arm 39.

For picking up an item, the linear motor 38 drives displacement of the gripper 40 towards a gripping position that has been predetermined on the basis of signals a control unit 41 of the control circuitry 32 has received from at least one of the detector unit 8. The control circuitry 32 is arranged for controlling the linear motor 38 for displacing the gripper 40 towards the gripping position until either the gripping position is reached or a resistance preventing the gripper 40 from reaching the gripping position is encountered.

That a linear motor drives displacements of the gripper towards the predetermined gripping position provides the advantage that a linear motor is particularly suitable to be arranged such that if the item to be gripped is for instance substantially higher than foreseen, the force exerted by the motor remains limited to such an extent that no damage is caused. After the linear motor 38 stops the driving of the gripper 40 towards the predetermined gripping position in response to the resistance preventing the gripper 40 from reaching the gripping position, the linear motor is subsequently controlled to lift the item to be picked up from the conveyor 4.

The horizontal position of items to be picked up is determined by the detector unit 8. Variations in the height of the items to be picked up larger than variations that can be accommodated by the flexibility of the gripper 40 can be accommodated in a simple manner, because the linear motor 38 is arranged for driving displacements of the gripper 40 with a vertical directional component. If during vertical downward displacement to a predetermined gripping position the item to be picked up is encountered earlier than foreseen, the forces exerted by the linear motor remain limited, so that damage to the robot or the conveyor is avoided. Accordingly, the accuracy in vertical direction of the predetermined gripping position is not critical. In turn, this allows to determine the level above the conveyor track 5 of the predetermined gripping position to be determined roughly, such that it is ensured that the item to be picked up is at least reached and picked up. Preferably, the predetermined gripping position is always at the same level. This level is preferably low enough to grip any item to be picked up. The flexibility of the gripper 40 can than be used to accommodate to the height of items extending to a slightly higher level than the level of the predetermined gripping position, while the limited force exerted by the linear motor 38 and the automatic stopping of the motor when an obstacle is encountered, allows to accommodate to items to be picked up that extend more above the level of the predetermined gripping position than can be accommodated by the flexibility of the gripper or other elastic means that may be provided.

In the present example, the control circuitry 32 is arranged for, in response to a current powering the linear motor 38 exceeding a predetermined amperage, controlling the linear motor 38 for stopping the driving of the displacement of the gripper 40 towards the gripping position. This allows stopping the motor 38 quickly and does not require complicated sensors.

The stopping of driving the displacement of the gripper 40 towards the gripping position may also be carried out in response to delays of displacements sensed by the robot compared with a predetermined time-displacement relationship.

The system according to the present example is equipped with a plurality of the robots 1.1-1.8 that are each equipped with a plurality of arms 34, 35, 39 and a plurality of motors for driving the robot arms 34, 35, 39. Because the control circuitry 32 is equipped with the central control unit 41 that communicates with the detector unit 8 and that communicating with the motors of the robots 1.1-1.8 and is arranged for determining control signals for the motors of the robots 1.1-1.8 from signals received from the detector unit 8, a particularly low cost robot control structure can be obtained.

The central control unit 41 in the present example is integrated to such an extent that it is arranged for determining analog control currents for the motors of the robots 1.1-1.8. Amplifiers for amplifying the control currents are preferably also arranged at or near the control unit 41, so that little or no circuitry at the robots is required, which is advantageous for ease of assembly and maintenance.

A problem that is particular to waste sorting is that a wide variety of items is processed. For instance, apart from items of a relatively compact shape, also items that are very elongate in one or two directions and very flexible may be included in the waste. Such items, such as rope, wire, textile and foil can easily cling or hook-up to equipment along the conveyor and in particular to robot arms that operate in close proximity of the waste stream. According to the present example, the control circuitry 32 is arranged for generating a signal indicative of material clinging to a robot 1.1-1.8 in response to resistance encountered during upward movement of the gripper 40 of that robot exceeding a threshold level. Thus, materials clinging or hooked to the robot arm 39 are automatically detected.

The signal may cause the robot to which the signal relates to perform a shake-off movement and/or to switch a valve 43 to a position for blowing air out of at least the gripper 40, so that in most cases the material clinging to the robot arm 39 is removed automatically. The valve 43 is arranged for switching between an off position, a position for feeding pressurized air to a venturi at the gripper 40 for generating a vacuum and to a conduit for feeding pressurized air directly into the gripper 40 to quickly release picked up items. Because the venture is arranged at the gripper 40 or integrated in the gripper, build-up of a vacuum in the gripper 40 as well as ending the vacuum condition can be realized particularly quickly.

Additionally, the signal may cause a humanly perceptible alarm, such as a sound and/or a visual alarm, to be generated if the automatic material removal operations do not result in removal of the material clinging to the robot arm 39 within a preset period of time. For safety reasons, the robot for which the signal indicative of material clinging to the robot has been generated is preferably brought into a position where the arm 39 can be reached most easily by an operator and stopped awaiting removal of the material by the operator. A control allowing the operator to restarting the robot is preferably positioned near or on the robot, so that the robot can be restarted as quickly as possible after the material clinging thereto has been removed manually.

Alternatively, the signal may only cause a humanly perceptible alarm to be generated, or the humanly perceptible alarm may be generated directly in response to the signal indicative of material clinging to one of the robots, so that an operator can be in place earlier in the event automatic measures to dispose of material clinging to a robot do not result in disengagement of the material.

Material clinging to the vertical robot arm 39, can be detected in a similar manner as detection of items to be picked up that are higher than a predetermined level of a pick-up position. It is preferred to detect clinging materials by detecting a current powering any motor of the robots 1.1-1.8 exceeding a predetermined maximum amperage associated to the respective motor, because materials clinging to the robot are often flexible enough to allow the robot to make the movements determined by the control unit 41, but cause the robot to exert more force and accordingly to consume more power when making movements, which increased power consumption can easily be detected as an indication of material clinging to the robot.

After an item has been picked up, it is advantageous for achieving a high capacity, if the item is deposited in one of the depositing areas quickly. In the system according to the present example, quick deposition of picked up items is achieved by providing that the control circuitry 32 is arranged for controlling the robots for each time depositing a picked-up item by performing a movement having a horizontal directional component from a starting point towards the selected one of the depositing areas 11-15, 17 and for releasing the picked up item before the gripper 40 has reached a position above the selected depositing area 11-15, 17. Thus, the gripper 40 does not need to make a movement over the whole horizontal distance to the selected depositing area. The momentum of the item to be deposited causes the item to follow a ballistic path toward the selected depositing area after the gripper 40 has released it. A particular advantage of the horizontal displacement over only a portion of the full distance to the depositing area 11-15, 17 is that it requires no additional degree of movability of the gripper. The distance over which the item to be deposited needs to be moved horizontally towards the selected depositing area 11-15, 17 can be reduced by providing that the gripper 40 is simultaneously moved upwardly until the item to be deposited is released.

From the foregoing, it will be clear to the skilled person, that within the framework of invention as set forth in the claims also many variations other than the examples described above are conceivable.

What is claimed is:

1. A system for sorting items out of waste material, comprising:
a conveyor for transporting waste material;
a detector for identifying and locating items of the waste material on the conveyor;
at least one depositing area along the conveyor;
at least one robot along the conveyor; and
a control circuitry communicating with the detector and with the robots for controlling the robot or at least one of the robots to pick-up located items of the waste material on the conveyor and to deposit picked-up items in the at least one depositing area.

2. A system for sorting items out of waste material, comprising:
a conveyor for transporting waste material;
a detector for identifying and locating items of the waste material on the conveyor;
at least one depositing area along the conveyor;
a plurality of the robots along the conveyor, each of the robots comprising a plurality of arms and a plurality of motors for driving the robot arms; and
a control circuitry communicating with the detector and with the robots for controlling the robots to pick-up located items of the waste material on the conveyor and to deposit picked-up items in the at least one depositing area,
wherein the control circuitry comprises a central control unit communicating with the at least one detector and communicating with the motors of the robots, the central control unit being arranged for determining control signals for the motors of the robots from signals received from the at least one detector.

3. A system according to claim 2, wherein the central control unit is arranged for determining analog control signals for the motors of the robots.

4. A system according to claim 1, wherein the control circuitry is arranged for controlling the robot or at least one of the robots for each time depositing a picked-up item at the at least one depositing area by performing a movement having a horizontal directional component from a starting point towards the depositing area and for releasing the picked-up item before the gripper has reached a position above the depositing area.

5. A system according to claim 1, wherein the control circuitry is arranged for generating a signal indicative of material clinging to the robot in response to resistance encountered during upward movement of a gripper of the at least one robot exceeding a threshold level.

6. A system according to claim 5, wherein the control circuitry is arranged for generating the signal indicative of material clinging to the robot in response to a current powering any motor of the robot or at least one of the robots exceeding a predetermined maximum amperage associated to the respective motor.

7. A system according to claim 5, wherein the control circuitry is arranged for controlling the robot or the one of the robots for performing a shake-off movement in response to the signal indicative of material clinging to the robot.

8. A system according to claim 5, wherein the robot or the one of the robots includes a valve for switching between applying a vacuum to the gripper and blowing air out of at least the gripper, the control circuitry being arranged for controlling the robot or the one of the robots for switching to the blowing air out of at least the gripper in response to the signal indicative of material clinging to the robot.

9. A system according to claim 1, wherein the at least one robot includes a gripper for engaging items to be picked up, a linear motor for driving displacement of the gripper in at least one direction towards a predetermined gripping position, the control circuitry being arranged for controlling the linear motor to displace the gripper towards the gripping position until either the gripping position is reached or a resistance preventing the gripper from reaching the gripping position is encountered.

10. A system according to claim 9, wherein the linear motor is arranged for driving at least displacements of the gripper with a vertical directional component.

11. A system according to claim 9, wherein the control circuitry is arranged for, in response to a current powering the linear motor exceeding a predetermined amperage, controlling the linear motor for stopping the driving of the displacement of the gripper towards the gripping position.

12. A system according to claim 9, wherein the control circuitry is arranged for, in response to powering the linear motor for driving displacement towards the gripping position exceeding a predetermined duration, controlling the linear motor for stopping the driving of the displacement of the gripper towards the gripping position.

13. A system according to claim 1, wherein the robots are arranged in at least two rows in longitudinal direction of the conveyor.

14. A system according to claim 13, wherein the rows of robots are staggered relative to each other.

15. A system according to claim 1, wherein at least two parallel conveyor paths in longitudinal direction of the conveyor track are arranged underneath the conveyor track, and wherein the depositing areas connect to chutes each leading to one of the conveyor paths underneath the conveyor track.

16. A system according to claim 15, wherein the depositing areas are located on opposite sides of the track, at least one of the depositing areas on each side of the conveyor track connecting to chutes leading to an outer one of the conveyor paths, the control unit, the chutes and the robots being arranged for depositing items of the same category onto said outer tracks.

17. A system according to claim 15, wherein the depositing areas include depositing areas on opposite sides of the track, each one of the conveyor paths being connected to at least one of the depositing areas on each side of the conveyor track.

18. A method for sorting items out of waste material, comprising:
providing at least one depositing area along a conveyor track;
providing at least one robot along the conveyor track;
transporting waste material along the conveyor track;
identifying and locating items of the waste material on the conveyor track; and
controlling the robot or at least one of the robots to pick-up located items of the waste material on the conveyor track and to deposit picked-up items at the at least one depositing area.

19. A method according to claim 18, wherein the depositing of a picked-up item at the at least one depositing area is performed by movement of the picked-up item having a horizontal directional component from a starting point towards the depositing area and releasing the picked-up item before the gripper has reached a position above the depositing area.

20. A method according to claim 18, wherein a signal indicative of material clinging to the robot is generated in response to resistance exceeding a threshold level encountered during upward movement of a gripper of the at least one robot.

21. A method according to claim 20, wherein the signal indicative of material clinging to the robot is generated in response to a current powering a motor of the robot or at least one of the robots exceeding a predetermined maximum amperage associated to the respective motor.

22. A method according to claim 20, wherein the robot or the one of the robots performs a shake-off movement in response to the signal indicative of material clinging to the robot.

23. A method according to claim 20, wherein the robot or the one of the robots blows air out of at least the gripper in response to the signal indicative of material clinging to the robot.

24. A method according to claim 18, wherein a gripper of the at least one robot engages items to be picked up, a linear motor drives displacements of the gripper in at least one direction towards a predetermined gripping position, and the linear motor stops the driving of the displacement of the gripper towards the gripping position in response to resistance preventing the gripper from reaching the gripping position.

25. A method according to claim 24, wherein the linear motor drives at least displacements of the gripper with a vertical directional component.

26. A method according to claim 24, wherein the linear motor stops the driving of the displacement of the gripper towards the gripping position in response to a current powering the linear motor exceeding a predetermined amperage.

27. A method according to claim 24, wherein the linear motor stops the driving of the displacement of the gripper towards the gripping position in response to powering the linear motor for driving displacement towards the gripping position exceeding a predetermined duration.
